(19) United States
(12) Patent Application Publication
(10) Pub. No.: US 2025/0244232 A1
(43) Pub. Date: Jul. 31, 2025

(54) METHODS OF DETERMINING OPTICAL PROPERTIES OF PARTICULATE MATERIALS USING A COMPOSITE SAMPLE AND RELATED SYSTEMS

(71) Applicant: The Government of the United States of America, as represented by the Secretary of the Navy, Arlington, VA (US)

(72) Inventors: Jesse A. Frantz, Washington, DC (US); Cobey L. McGinnis, Springfield, VA (US); Jason D. Myers, Alexandria, VA (US); Anthony R. Clabeau, Westminster, CA (US); Jasbinder S. Sanghera, Ashburn, VA (US); Kenneth J. Ewing, Edgewater, MD (US); Matthew B. Hart, Silver Spring, MD (US); Abbie T. Watnik, Washington, DC (US)

(73) Assignee: The Government of the United States of America, as represented by the Secretary of the Navy, Arlington, VA (US)

(21) Appl. No.: 19/036,605

(22) Filed: Jan. 24, 2025

Related U.S. Application Data
(60) Provisional application No. 63/625,794, filed on Jan. 26, 2024.

(51) Int. Cl. G01N 21/21; G01N 21/84

(52) U.S. Cl. CPC G01N 21/211; G01N 21/8422; G01N 2021/213

(57) ABSTRACT

Some embodiments of the present disclosure provide a method of determining optical properties of a particulate material. A first optical model for a matrix material is provided, and a composite sample having a polished surface is provided with the composite sample including a mixture of the particulate material in the matrix material. Spectroscopic ellipsometry is performed on the polished surface of the composite sample to provide spectroscopic ellipsometry data for the composite sample. A second optical model is generated for the particulate material based on the spectroscopic ellipsometry data for the composite sample and based on the first optical model for the matrix material.

### CROSS-REFERENCE TO RELATED APPLICATIONS

This Application is a Nonprovisional Utility Patent Application and claims the benefit of priority under 35 U.S.C. Sec. 119 based on U.S. Provisional Patent Application No. 63/625,794 filed on Jan. 26, 2024. The disclosure of Provisional Application No. 63/625,794 and all references cited herein are hereby incorporated in their entirety by reference into the present disclosure.

### FEDERALLY SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; nrltechtran@us.navy.mil, referencing Navy Case #211972-US1.

### TECHNICAL FIELD

The present disclosure relates to methods of determining optical properties of particulate material.

### BACKGROUND OF THE INVENTION

Understanding light propagation in the presence of particles suspended in a medium may be important for a wide range of applications. These applications may include atmospheric modeling (see, Reference [1]), free space optical communications where a signal must be maintained even in the presence of degradation from scattering particles (see References [2], [3], and [4]), a wide variety of lidar applications (see, References [5] and [6]), and astronomical measurements in which the effects of cosmic dust must be accounted for (see, Reference [7]). In order to properly model the propagation of light in these and other circumstances, knowledge of the index of refraction n(λ) and the extinction coefficient k(λ) (each as a function of wavelength λ) of the sand and dust particles may be useful/required. While the primary component of most sand and dust particles is silica, samples taken from the environment may be a rich mixture of different localized compositions and phases, making the optical properties of individual samples unique (see, References [8] and [9]).

Despite this situation, data for n(λ) and k(λ) of sand and dust may be difficult to obtain. Literature values are available for silica and other pure phases, but for real environmental samples, these quantities should be measured on an individual basis. For dense, solid materials that can be polished, their optical constants may be determined by well-established methods such as refractometry, spectroscopic ellipsometry (SE), and/or spectroscopic measurements. For particulate samples, however, these methods often cannot be applied. Refractometry and SE rely, respectively, on transmittance through and specular reflection from smooth surfaces. In some specific cases, a particulate sample can be processed into a disc with sufficient reflectance for SE. For example, it has been shown that some very fine dust can be cold pressed into pellets with a sufficiently smooth surface that SE may be performed (see, Reference [10]). Usually, however, a pressed pellet may have a surface that is too rough for SE and/or that is too porous and/or to friable to be effectively polished. Alternatively, it may be possible to perform SE on particles if they can be collected at an interface (see, Reference [11]), but this too may only work for very specific samples and may not be generally applicable.

Spectroscopic measurements can also be applied to determine the optical constants of particulate samples. In one commonly used technique, particles are mixed into a transparent matrix such as potassium bromide KBr (see, References, [10], [12], and [13]). Similarly, atmospheric measurements can be carried out on air in which particles are present. Measurements of transmittance and reflectance of light through the suspended particles are carried out, and the Kramers-Kronig relation (integral equations relating the real and imaginary parts of the index of refraction) are applied to determine the optical constants. In these cases, however, several assumptions may typically be made (e.g., particle shape and size distribution). Accordingly, this method may yield imprecise results that do not accurately capture all of the important features of n(λ) and k(λ).

### SUMMARY OF THE INVENTION

This summary is intended to introduce in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

According to some embodiments of inventive concepts, a method of determining optical properties of a particulate material is provided. A first optical model is provided for a matrix material, and a composite sample having a polished surface is provided with the composite sample including a mixture of the particulate material in the matrix material. Spectroscopic ellipsometry is performed on the polished surface of the composite sample to provide spectroscopic ellipsometry data for the composite sample. A second optical model is generated for the particulate material based on the spectroscopic ellipsometry data for the composite sample and based on the first optical model for the matrix material.

The first and second optical models may be respective first and second optical oscillator models.

The second optical model of the particulate material may be generated based on the spectroscopic ellipsometry data for the composite sample, based on the first optical model, and based on an estimate of a proportion of the polished surface that is made up of the particulate material.

The second optical model may be generated as a best fit to the spectroscopic ellipsometry data for the composite sample based on the first optical model and based on the estimate of the proportion of the polished surface that is made up of the particulate material. The estimate of the proportion of the polished surface that is made up of the particulate material may be determined based on proportions of the particulate material and the matrix material in the composite sample. The proportions of the particulate material and the matrix material in the composite sample may be volumetric proportions.

Providing the first optical model for the matrix material may include: providing a reference sample having a polished surface, wherein the reference sample comprises the matrix material without the particulate material; performing spectroscopic ellipsometry on the polished surface of the reference sample to provide spectroscopic ellipsometry data for the reference sample; and generating the first optical model for the matrix material based on the spectroscopic ellipsometry data for the reference sample.

According to some other embodiments of inventive concepts, a system may be provided to determine optical properties of a particulate material, and the system may include a spectroscopic ellipsometer and a controller coupled with the spectroscopic ellipsometer. The spectroscopic ellipsometer is configured to perform spectroscopic ellipsometry on a polished surface of a composite sample to provide spectroscopic ellipsometry data for the composite sample. The controller is coupled with the spectroscopic ellipsometer wherein the controller is configured to generate an optical model for the particulate material based on the spectroscopic ellipsometry data for the composite sample and based on an optical model for the matrix material.

### BRIEF DESCRIPTION OF DRAWINGS

Examples of embodiments of inventive concepts may be more clearly understood from the following detailed description taken in conjunction with the accompanying drawings in which:

FIGS. 1A and 1B are respective top and cross-sectional views of a composite sample including particles in a matrix according to some embodiments of inventive concepts;

FIG. 2 is a flow chart illustrating operations to determine optical properties of particulate material according to some embodiments of inventive concepts;

FIG. 3A illustrates a pure crystalbond sample provided as a reference sample according to some embodiments of inventive concepts;

FIG. 3B illustrates a composite sample of sand as a particulate material and crystalbond as a matrix material in a Teflon beaker according to some embodiments of inventive concepts;

FIG. 3C illustrates the composite sample of FIG. 3B after polishing according to some embodiments of inventive concepts;

FIG. 3D illustrates a magnified image of the polished surface of the composite sample of FIG. 3C according to some embodiments of inventive concepts;

FIGS. 4A, 4B, and 4C illustrated measured values of n(λ) and k(λ) for respective sand samples 1, 2, and 3 according to some embodiments of inventive concepts, and the insets illustrate images of the respective polished composite samples;

FIGS. 5A, 6A, and 7A illustrate respective plots of magnitude of Cₑₓₜ for sand samples 1, 2, and 3 according to some embodiments of inventive concepts;

FIGS. 5B, 6B, and 7B illustrate respective plots of Cₑₓₜ for specific values of particle diameter for sand samples 1, 2, and 3 according to some embodiments of inventive concepts; and

FIG. 8 is a block diagram illustrating a system according to some embodiments of inventive concepts.

### DETAILED DESCRIPTION OF THE INVENTION

Aspects and features of the present disclosure will now be described more fully with reference to the accompanying drawings. The following description shows, by way of example, combinations and configurations in which aspects, features, and embodiments of inventive concepts can be put into practice. It will be understood that the disclosed aspects, features, and/or embodiments are merely examples, and that one skilled in the art may use other aspects, features, and/or embodiments or make functional and/or structural modifications without departing from the scope of the present disclosure. Moreover, like reference numerals refer to like elements throughout, and sizes of each of the elements may be exaggerated for clarity and conveniences of explanation.

According to some embodiments of inventive concepts, methods and systems are provided to perform spectroscopic ellipsometry to determine the optical constants of particulate samples. Some embodiments of inventive concepts may also provide methods of using this data to predict the wavelength of a Christiansen feature for a given particulate sample.

SE techniques have become a primary tool to obtain high precision values of the optical constants of materials (see, Reference [14]), and ideally, these techniques would be applicable to particulate samples. According to some embodiments of inventive concepts, a composite sample including particulate material embedded in an adhesive matrix can be used to provide SE measurements. According to some other embodiments of inventive concepts, methods may be provided to use such a composite sample in SE measurements and to extract optical constants of the particulate material. In addition, some embodiments of inventive concepts may provide that this optical constant data may be input into a rigorous scattering model to predict transmittance through the particles in the situation where they are outside of the composite sample and embedded or suspended in another medium such as air.

According to some embodiments of inventive concepts, a composite sample includes at least two main components, a solid matrix material and a particulate material, wherein particles of the particulate material are suspended in the matrix material. At least one first surface of the composite sample (e.g., a “top” or “front” surface of the composite sample) is polished via standard optical polishing techniques such that it is smooth enough to have a reflection with a sufficiently large specular component to perform SE measurements in the wavelength range of interest. A second surface of the composite sample (e.g., a “bottom” or “back” surface that is opposite the first surface) may be ground flat but left sufficiently rough so that its reflection is primarily diffuse in the wavelength range of interest. Alternately, the second surface may also be polished.

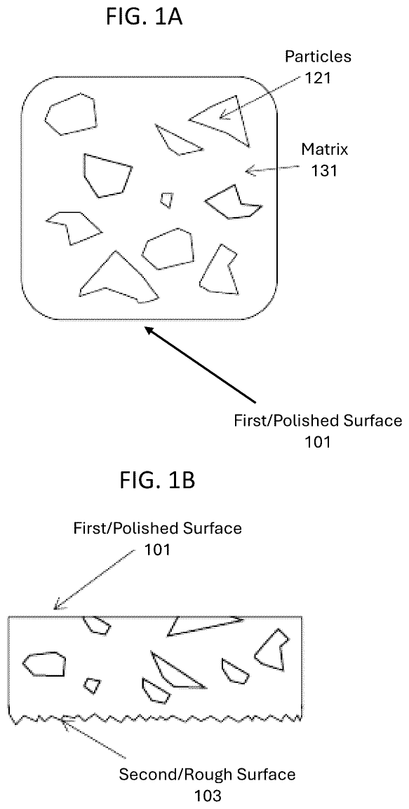

Some embodiments of inventive concepts are illustrated with respect to FIGS. 1A and 1B. FIG. 1A shows the first surface 101 of the composite sample (e.g., a top polished surface 101), indicating both a matrix 131 and particles 121 within the matrix 131, and FIG. 1B shows a cross-sectional view (also referred to as a side view) of the composite sample with the polished first surface 101 and rough second surface 103. Lateral dimensions of the composite sample are chosen to be large enough that a light beam in a typical SE instrument fits within the surface (for example, the composite sample may have a diameter in the range of 5 mm to 50 mm).

Dimensions of particles 121 may be sufficiently small such that a light beam in a typical SE instrument encounters multiple particles 121 as well as material of matrix 131. A typical particle size may be in the range of 0.1 μm to 500 μm). Particles 121 may not all be the same size, and particles 121 may instead represent a distribution of sizes. In addition, particles 121 may have a variety of different shapes. A typical volume fill factor for particulate material may be in a range of 5% to 80% of the total sample volume. When first surface 101 of the composite sample is polished, the first/polished surface 101 may contain a cross section of some of particles 121, i.e., first surface 101 may include areas of both matrix and particle material, while other particles 121 will be located entirely beneath/behind first surface 101. Measurements should thus retrieve data for a sufficiently large area of the composite sample to average across multiple particles 121.

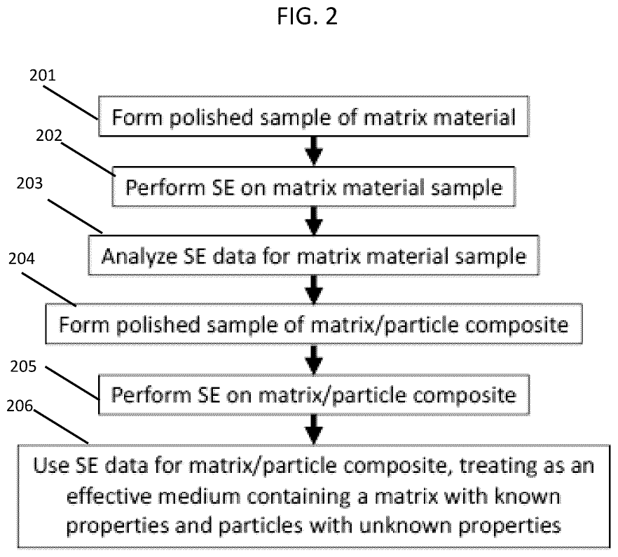

The composite sample described above with respect to FIGS. 1A and 1B may then be used in SE measurements. Operations used to determine the optical constants of the particulate material are discussed below with respect to the flow chart of FIG. 2.

At operation 201, a polished reference sample of the matrix material is formed on its own without the presence of the particulate material. The polished reference sample is of the same approximate size and shape as the composite sample of FIGS. 1A and 1B, and the polished reference sample may also have one flat but rough surface. At operation 202, SE is performed on the reference sample of the matrix material. At operation 203, SE data for the reference sample of the matrix material is analyzed. The SE data is fit (for example using standard ellipsometry analysis software), and the optical properties of the matrix material are recorded. At operation 204, a polished composite sample is formed including the matrix material and the unknown particle material. At operation 205, SE is performed on the composite sample including the particles and the matrix material as discussed above with respect to FIGS. 1A and 1B. At operation 206, the SE data for the composite sample (from operation 205) is used, treating it as an effective medium containing the matrix material (which now has known properties from Operation 203), combined with particles with unknown properties, where the fill factor for the particulate material may be treated as a fit parameter. This fitting allows for the determination of the optical properties of the particulate material.

The optical properties of the particulate material may then be used to predict how light will propagate through a collection of particles of this material. With knowledge of n(λ) and k(λ) for the particulate material, it is possible to calculate how a scattering particle will interact with incident light over a given wavelength range. Specifically, it is possible to calculate the scattering cross section, C_{sca}, absorption cross section, C_{abs}, and the extinction cross section, where Cₑₓₜ=C_{sca}+C_{abs}. These quantities, respectively, represent areas that are proportional to the amount of light scattered, absorbed, and extinguished by the scatterer. For example, a rigorous model, based on Maxwell's equations may be applied where data for n(λ) and k(λ), determined by SE, are input into this model. The values of C_{sca}, C_{abs}, and Cₑₓₜ may then be determined.

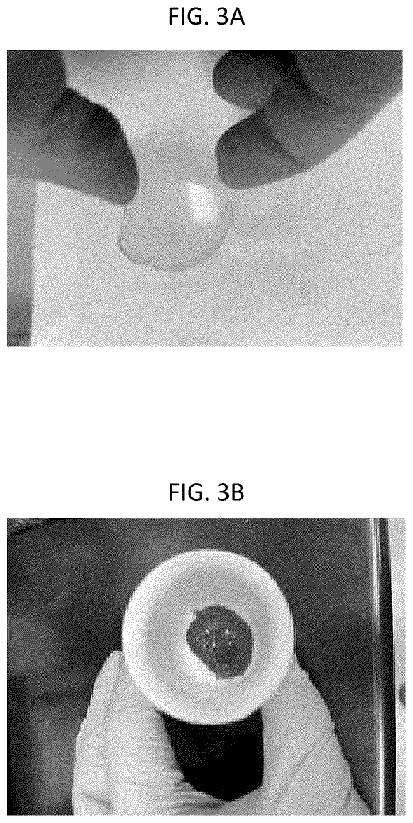

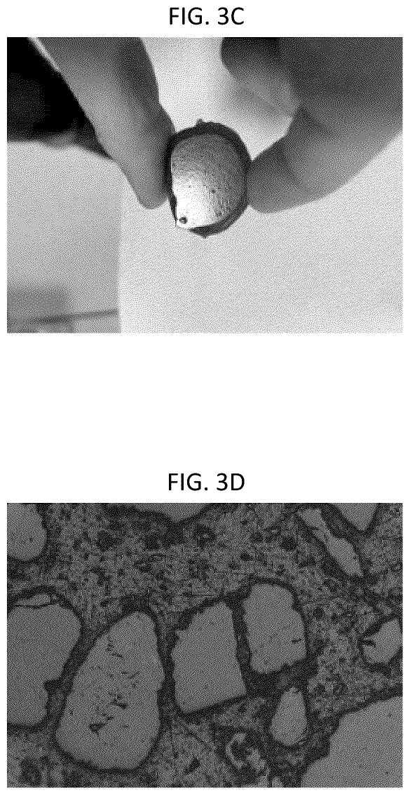

Some embodiments of inventive concepts have been reduced to practice via a series of laboratory measurements and simulations. Samples were prepared by embedding particulate samples in Crystalbond 509—a clear polymerized solid mixture with low flow temperature (121° C.), typically used for sample mounting. A relatively pure Crystalbond sample was formed by melting Crystalbond in a metal-bottomed Teflon beaker on a hot plate. Composite samples of three different desert sand samples, labeled “Sand 1,” “Sand 2,” and “Sand 3” (that were gathered from the ground at different desert locations) were prepared. For these samples, Crystalbond and particulate material were batched into a Teflon beaker in a 50/50 ratio by weight. The beaker was placed on a hot plate, the Crystalbond was melted, and the sample was thoroughly mixed to form a composite. For all samples, standard optical polishing techniques were applied to finish the front surface, and the back surface was ground to a diffuse finish. Finished samples were in the range of 2 mm to 5 mm thick. Images of a pure Crystalbond sample, a composite Crystalbond/sand sample in the Teflon beaker, a polished composite sample, and a microscope image showing the cross section of a polished sample are respectively shown in FIGS. 3A, 3B, 3C, and 3D. Note that while the polish on the composite sample shown in FIG. 1C is imperfect, and there is some reflected scatter, it is evident from the image that the reflection contains a strong specular component. The microscope image in FIG. 3D shows sand grains of varying size and indicates that some grains are polished in cross section.

SE was performed in an infrared spectroscopic ellipsometer (Woollam, IR-VASE) for a wavelength range of 1.7 μm to 30 μm. The ellipsometric parameters Ψ and Δ were measured at 55°, 65°, and 75° incident angles. This data was then fit according to an oscillator model described by Frantz et al. (see, Reference [15]) that treats the dielectric function as a summation of complex terms with defined functional forms. This model includes a constant offset term, ε₁(∞), to account for the effect of resonances outside of the spectral range analyzed. It also includes a Sellmeier term—a zero-width Lorentz oscillator, or “pole,” with position given by E₀ and magnitude given by A₀ to account for the absorption outside of the measured range. This term may be expressed as:

$${ε}_{1} ( E ) = 1 + \frac{A {E}_{0}^{2}}{{E}_{0}^{2} - {E}^{2}} . \qquad Equation ( 1 )$$

Organic compounds such as Crystalbond are known to be fit especially well with Gaussian oscillators (see, Reference [16]), and it is found in this work that real sand samples, with multiple absorptions at different energies are also well-described by Gaussian terms. These terms have the form:

$${ε}_{2 , j} ( E ) = {A}_{j} exp - {( \frac{E - {E}_{0 , j}}{{σ}_{j}} )}^{2} - {A}_{j} exp - {( \frac{E + {E}_{0 , j}}{{σ}_{j}} )}^{2} \qquad Equation ( 2 )$$

where each has three fit parameters, the amplitude Aⱼ, center energy, E_{0,j}, and broadening σⱼ where Aⱼ is unitless and E_{0,j} and σⱼ are in units of eV. Thus, the complex dielectric function as a whole may be written as:

$$ε ( E ) = {ε}_{1} ( E ) - i {ε}_{2} ( E ) = {ε}_{1} ( ∞ ) + {ε}_{1} ( E ) - {\sum }_{j} i {ε}_{2 , j} ( E ) , \qquad Equation ( 3 )$$

where ε₁(E) is given by Equation 1 and the ε_{2,j} terms are described by Equation 2.

The Crystalbond material was then fit with this model, and was found to be fit well with a general oscillator model with 19 Gaussian oscillators. The best fit provided values of ε₁(∞)=1.41, E₀=9.61 eV, and A₀=89.0. The values for the Gaussian oscillator fit parameters are provided in Table 1.

TABLE 1
Fit Parameters for Gaussian terms for Crystalbond

| Oscillator index, j | E_{0, j} (eV) | Aⱼ | σⱼ (eV) |
|---|---|---|---|
| 1 | 0.0919 | 0.640 | 1.55E−03 |
| 2 | 0.0933 | 0.304 | 9.70E−03 |
| 3 | 0.1087 | 0.150 | 1.10E−02 |
| 4 | 0.1216 | 0.070 | 8.57E−03 |
| 5 | 0.1261 | 0.068 | 2.21E−03 |
| 6 | 0.1296 | 0.474 | 3.19E−03 |
| 7 | 0.1330 | 0.889 | 2.61E−03 |
| 8 | 0.1400 | 0.922 | 5.60E−03 |
| 9 | 0.1575 | 1.664 | 7.02E−03 |
| 10 | 0.1664 | 0.088 | 2.58E−03 |
| 11 | 0.1699 | 0.222 | 2.08E−03 |
| 12 | 0.1739 | 0.111 | 3.45E−03 |
| 13 | 0.1793 | 0.206 | 2.96E−03 |
| 14 | 0.1845 | 0.064 | 3.42E−03 |
| 15 | 0.1958 | 0.116 | 1.13E−03 |
| 16 | 0.1993 | 0.094 | 1.38E−03 |
| 17 | 0.2032 | 0.028 | 8.02E−02 |
| 18 | 0.2141 | 1.570 | 3.79E−03 |
| 19 | 0.2185 | 0.073 | 1.40E−02 |

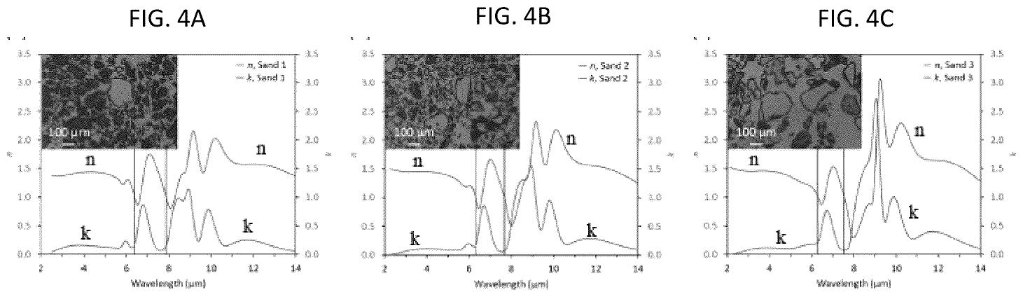

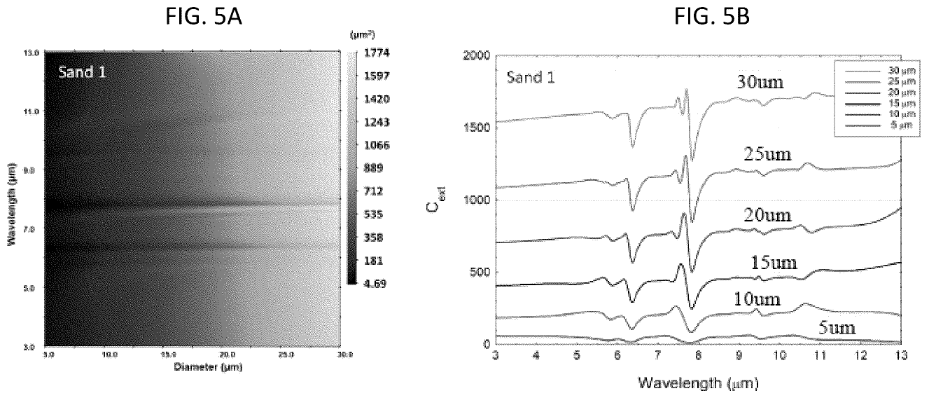

Next, composite samples of desert sand embedded in Crystalbond were evaluated. SE was carried out, and the data were fit, treating the sample as a Bruggeman effective medium composed of Crystalbond, with fixed fit parameters described above, and a material with unknown properties, representing sand. The ratio of sand to Crystalbond is treated as a fit parameter in order to account for the amount of sand versus Crystalbond being probed. For Sand 1, a best fit was obtained with a 21.9% sand fraction as a fit parameter with 8 Gaussian oscillators. For Sand 2, a best fit was obtained with a 25.8% sand fraction with 8 Gaussian oscillators. For Sand 3, a best fit was obtained with a 29.2% sand fraction with 8 Gaussian oscillators. Measured n(λ) and k(λ) are shown in FIG. 4A for Sand 1, in FIG. 4B for Sand 2, and in FIG. 4C for Sand 3. The insets in each of the figures show microscope images of cross sections of the respective polished composite samples.

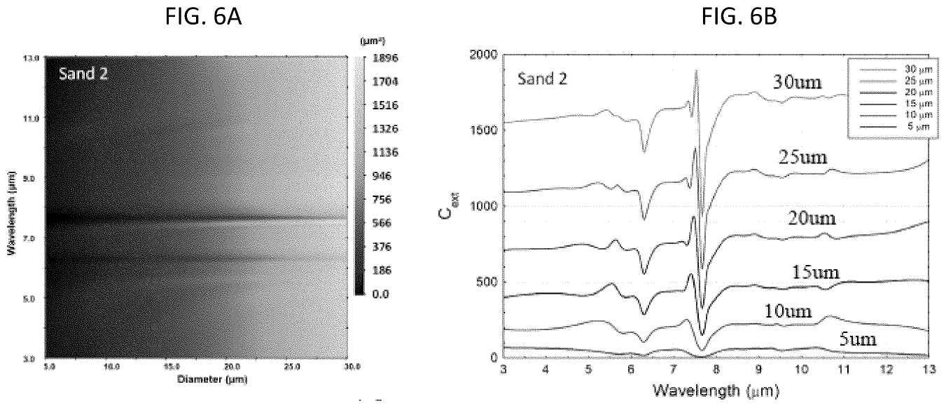

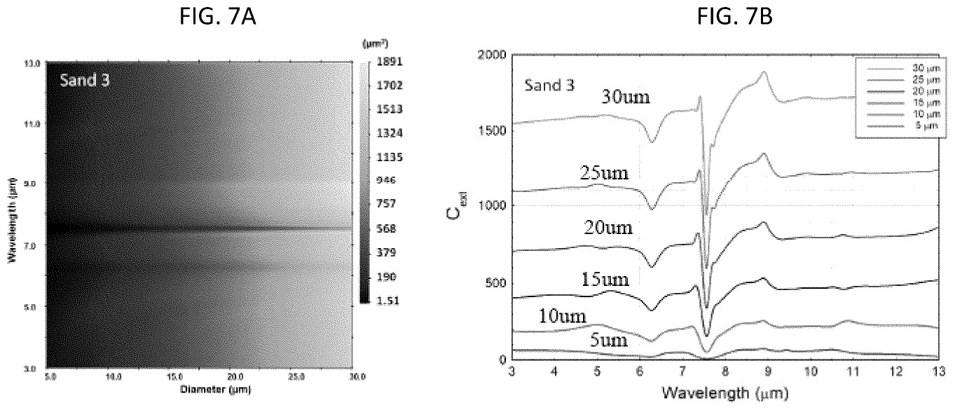

To fully evaluate the effects of scattering and absorption on transmittance through a sand sample, n(λ) and k(λ) for the sand sample were entered into the rigorous scattering model, and C_{sca}, C_{abs}, and Cₑₓₜ were calculated. The plots of FIG. 5A (for Sand 1), FIG. 6A (for Sand 2), and FIG. 7A (for Sand 3) show heat maps of the magnitude of Cₑₓₜ for each sand sample as a function of both particle diameter for a range of 5 μm to 30 μm and wavelength from λ=3 μm to 13 μm. The plots of FIG. 5B (for Sand 1), FIG. 6B (for Sand 2), and FIG. 7B (for Sand 3) show Cₑₓₜ for specific values of particle diameter. For Sands 1 and 2, Cₑₓₜ appears to be similar across particle diameter and 2 with subtle differences such as the magnitudes of the maxima and minima. For Sand 1, Cₑₓₜ has a minimum at λ=7.85 μm and Sand 2 has one at λ=7.64 μm, near the values of Ac determined above. Both also have a sharp increase in Cₑₓₜ immediately on the short wavelength side of the Christiansen feature. For Sand 3, Cₑₓₜ is similar in general but with several differences. The minimum value is at λ=7.56 μm, corresponding to its shorter 2c, and it has a higher peak near λ=9 μm corresponding to its high absorption. All of the sand samples show a secondary band of low Cₑₓₜ at λ≈6.3 μm.

Some embodiments of inventive concepts may provide one or more of the following advantages and/or features. For example, an apparatus and/or method may be provided to determine the optical constants of particulate materials, whereas no adequate method currently exists for such samples. Moreover, results in data that may be applied to predict how light propagates through a collection of particles of a given material.

A variety of alternatives may be provided according to additional embodiments of inventive concepts as discussed below.

For example, a material other than Crystalbond 509 may be used as the matrix material. The matrix material may be provided using a different thermal adhesive or a wax having a melting temperature different than that of Crystalbond 509. Alternately, the matrix material may be provided using a material that solidifies through a different mechanism such as an epoxy.

The matrix material may be chosen to have a particular set of optical properties, for example a specific refractive index, either to improve/optimize SE analysis and/or to better mimic real-word conditions. For example, the matrix may be selected to mimic the environment in which the particles are expected to be encountered in a particular application(s).

The matrix material may be chosen to have a particular chemical interaction with the particulate material, reacting with surfaces of the particles to provide better adhesion and/or to alter the optical properties of the particles to better imitate their surface properties as they are encountered in an expected application(s).

Instead of traditional wet polishing in water, the sample may be dry polished or polished using a non-aqueous liquid such as isopropyl alcohol. This may be useful in cases where the matrix material or particulate material dissolves or absorbs water.

The sample may be cryogenically polished (i.e., polished at low temperature). This may be useful if the matrix material and particulate material have disparate polishing rates at room temperature. The polishing temperature may be chosen such that the polishing rates are more similar, resulting in a smoother surface.

The composite sample may be heated or cooled on a thermal stage during SE in order to make measurements at a different temperature or range in temperatures. This measurement may be used to determine n(λ) and k(λ) at a different temperature or to determine the change in refractive index with respect to temperature (dn/dT).

The matrix material may be a liquid at room temperature, and a composite sample may be formed by suspending particles in the liquid and then freezing it. Then, SE may be performed at a temperature below room temperature in order to keep the matrix material frozen. For example, the matrix material may be liquid water and frozen into ice.

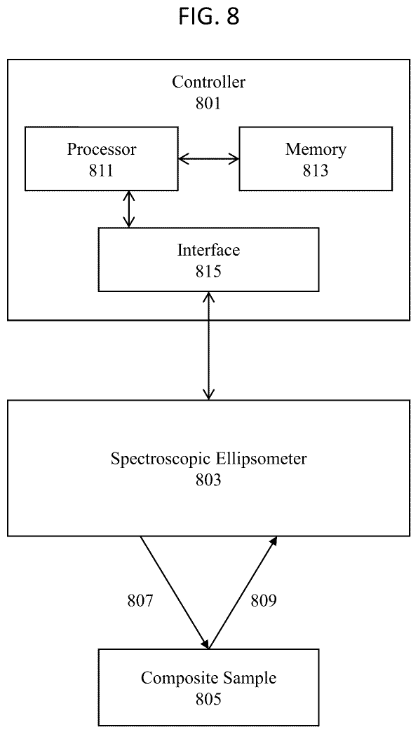

FIG. 8 is a block diagram illustrating a system used to determine optical properties of a particulate material according to some embodiments of inventive concepts. As shown in FIG. 8, the system includes controller 801 coupled with spectroscopic ellipsometer 803. Moreover, composite sample 805 includes a mixture of the particulate material and a matrix material with a polished surface as discussed above with respect to FIGS. 1A and 1B, and block 204 of FIG. 2. Spectroscopic ellipsometer 803 is configured to perform spectroscopic ellipsometry on the polished surface of composite sample 805 by projecting light signal 807 onto the polished surface of composite sample 805 and to generate spectroscopic ellipsometry data for composite sample 805 by measuring reflection 809 of light signal 807 as discussed above with respect to block 205 of FIG. 2.

As shown, controller 801 may include processor 811 (also referred to as processing circuitry), memory 813 (also referred to as memory circuitry), and communication interface 815 (also referred to as an interface or interface circuitry). Communication interface 815 is coupled with spectroscopic ellipsometer 803, and processor 811 is coupled with memory 813 and interface 815. Memory 813 may include computer readable program code that when executed by processor 811 causes processor 811 to perform operations according to embodiments disclosed herein. Accordingly, processor 811 may execute computer readable program code of memory 813 to perform operations as disclosed herein. According to other embodiments, processor 811 may be defined to include memory so that separate memory is not required. Accordingly, processor 811 can transmit instructions through interface 815 to control spectroscopic ellipsometer 803, and processor can receive information (e.g., spectroscopic ellipsometry data for composite sample 805) from spectroscopic ellipsometer 803.

According to some embodiments of inventive concepts, composite sample 805 includes a mixture of the particulate material in the matrix material, and composite sample 805 has a polished surface. Composite sample 805 may be provided as discussed above with respect to FIGS. 1A and 1B, and block 204 of FIG. 2. An optical model for the matrix material may be provided as discussed above with respect to blocks 201, 202, and 203 of FIG. 2. Spectroscopic ellipsometer 803 is configured to perform spectroscopic ellipsometry on the polished surface of composite sample 805 to provide spectroscopic ellipsometry data for composite sample 805 as discussed above with respect to block 205 of FIG. 2.

Controller 801 is configured to generate an optical model for the particulate material based on the spectroscopic ellipsometry data for composite sample 805 and based on the optical model for the matrix material as discussed above with respect to block 206 of FIG. 2. For example, processor 811 may receive the spectroscopic ellipsometry data for composite sample 805 from spectroscopic ellipsometer 803 through interface 815, and processor 811 may generate the optical model for the particulate material based on the spectroscopic ellipsometry data for composite sample 805 and based on the optical model for the matrix material from memory 813 using computer readable program code from memory 813.

In embodiments of FIG. 8, the optical model for the matrix material and the optical model for the composite particulate material may be respective optical oscillator models.

Controller 801 may be configured to generate the optical model of the particulate material based on the spectroscopic ellipsometry data for the composite sample, based on the optical model for the matrix material, and based on an estimate of a proportion of the polished surface that is made up of the particulate material. For example, processor 811 may be configured to generate the optical model of the particulate material based on the spectroscopic ellipsometry data for the composite sample (received from spectroscopic ellipsometer 803 through interface 815), based on the optical model for the matrix material (stored in memory 813), and based on an estimate of a proportion of the polished surface that is made up of the particulate material (stored in memory 813), using computer readable program code from memory 813. The estimate of the proportion of the polished surface that is made up of the particulate material, for example, may be separately estimated/measured and provided via a user through interface 815 and processor 811 to memory 813. In such embodiments, interface 815 may include a user interface such as a keyboard/keypad, a touch sensitive display, a mouse, a touch sensitive trackpad, etc.

Controller 801 may be configured to generate the optical model of the particulate material as a best fit to the spectroscopic ellipsometry data for the composite sample based on the optical model for the matrix material and based on the estimate of the proportion of the polished surface that is made up of the particulate material. For example, processor 811 may be configured to generate the optical model of the particulate material as a best fit to the spectroscopic ellipsometry data for the composite sample based on the optical model for the matrix material and based on the estimate of the proportion of the polished surface that is made up of the particulate material, using computer readable program code from memory 813. Moreover, the estimate of the proportion of the polished surface that is made up of the particulate material may be determined based on proportions of the particulate material and the matrix material in the composite sample, and/or the proportions of the particulate material and the matrix material in the composite sample may be volumetric proportions.

The following publications have been cited in the present disclosure, and the disclosures of each of these publications are hereby incorporated herein in their entireties by reference.
Reference [1]. JACOBSON, M. Z., Fundamentals of Atmospheric Modeling, Second Edition (Cambridge University Press, 2005).
Reference [2]. ESMAIL, et al., “Investigation and Demonstration of High Speed Full-Optical Hybrid FSO/Fiber Communication System Under Light Sand Storm Condition,” IEEE Photonics J (US), Vol. 9, No. 1, 13 pages, February 2017.
Reference [3]. BAO, M., et al., “Performance Evaluation of FSO Communications under Sand-Dust Conditions,” Int J Antennas Propag (UK), Vol. 2019, Article ID No. 2046896, 11 pages, October 2019.
Reference [4]. DE, S., et al., “Experimental Study of Sand-Storm Effect on Digital FSO Communication Link,” 2020 RTEICT IEEE (US), Bangalore, India, pages 35-40, 12-13 Nov. 2020.
Reference [5]. GASTEIGER, J., et al., “Modelling lidar-relevant optical properties of complex mineral dust aerosols,” Tellus B (SE), Vol. 63, Issue 4, pages 725-741, 1 Jan. 2011.
Reference [6]. PHILLIPS, T. G., et al., “When the Dust Settles: The Four Behaviors of LiDAR in the Presence of Fine Airborne Particulates: When the Dust Settles: The Four Behaviors of LiDAR in the Presence of Fine Airborne Particulates,” J Field Robot (US), Vol. 34, Issue 5, pages 985-1009, 10 Feb. 2017.
Reference [7]. DEMYK, K., et al., “Low-temperature optical constants of amorphous silicate dust analogues,” Astron Astrophys (FR), Vol. 66, A192, 24 pages, October 2022.
Reference [8]. TUMSAVAS, Z., et al., “Prediction and mapping of soil clay and sand contents using visible and near-infrared spectroscopy,” Biosyst Eng (NL), Vol. 177, pages 90-100, January 2019.
Reference [9]. DANESH, M., et al., “Modeling of Soil Sand Particles Using Spectroscopy Technology,” Commun Soil Sci Plant Anal (US), Vol. 53, Issue 17, pages 2216-2228, 29 Apr. 2021.
Reference [10]. HOOK, D. A., et al., “Understanding lidar returns from complex dust mixtures,” Proc. SPIE (US), Vol. 8731, Laser Radar Technology and Applications XVIII, 12 pages, 20 May 2013.
Reference [11]. BINKS, B. P., et al., “Ellipsometric Study of Monodisperse Silica Particles at an Oil-Water Interface,” Langmuir (US), Vol. 19, Issue 21, pages 8888-8893, 14 Oct. 2003.
Reference [12]. VOLZ, F. E., “Infrared Refractive Index of Atmospheric Aerosol Substances,” Appl Opt (US), Vol. 11, Issue 4, pages 755-759, April 1972.
Reference [13]. RUAN, L. M., et al., “Experimental investigation on optical constants of aerosol particles,” J Aerosol Sci (NL), Vol. 42, Issue 11, pages 759-770, November 2011.
Reference [14]. ASPNES, D. E., “Spectroscopic ellipsometry-Past, present, and future,” Thin Solid Films (NL), Vol. 571, pages 334-344, November 2014.
Reference [15]. FRANTZ, J. A., et al., “Measurement of the Optical Constants of Sand Samples Using Ellipsometry on Sand-Adhesive Composites,” Appl Spectrosc (US), Vol. 78, Issue 4, pages 403-411, April 2024.
Reference [16]. HILFIKER, J. N., et al., “Dielectric Function Modeling,” In: Fujiwara H, Collins R W (eds) Spectroscopic Ellipsometry for Photovoltaics. Cham: Springer International Publishing, pp. 115-153.

The terminology used herein is for the purpose of describing particular embodiments only and is not intended to be limiting of inventive concepts. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. The term “and/or” includes any and all combinations of one or more of the associated listed items.

Spatially relative terms, such as “beneath,” “below,” “lower,” “above,” “upper,” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations), and the spatially relative descriptors used herein may be interpreted accordingly.

It will be understood that, although the terms first, second, third, etc. may be used herein to describe various elements, these elements should not be limited by these terms. These terms are only used to distinguish one element from another element. Thus, a first element discussed herein could be termed a second element without departing from the scope of the present inventive concepts.

It will also be understood that when an element is referred to as being “on,” “connected” to/with, or “coupled” to/with another element, it can be directly on, directly connected to/with, or directly coupled to/with the other element, or intervening elements may be present. In contrast, when an element is referred to as being “directly on”, “directly connected” to/with, or “directly coupled” to/with another element, there are no intervening elements present. Moreover, if an element is referred to as being “on” another element, no spatial orientation is implied such that the element can be over the other element, under the other element, on a side of the other element, etc.

Embodiments are described herein with reference to cross-sectional and/or perspective illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

The operations of any methods disclosed herein do not have to be performed in the exact order disclosed, unless an operation is explicitly described as following or preceding another operation and/or where it is implicit that an operation must follow or precede another operation. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description herein.

Unless otherwise defined, all terms (including technical and scientific terms) used herein have the same meaning as commonly understood by one of ordinary skill in the art to which the inventive concepts herein belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While inventive concepts have been particularly shown and described with reference to examples of embodiments thereof, it will be understood that various changes in form and details may be made therein without departing from the spirit of the following claims.

1. A method of determining optical properties of a particulate material, the method comprising:
providing a first optical model for a matrix material;
providing a composite sample having a polished surface, wherein the composite sample comprises a mixture of the particulate material in the matrix material;
performing spectroscopic ellipsometry on the polished surface of the composite sample to provide spectroscopic ellipsometry data for the composite sample; and
generating a second optical model for the particulate material based on the spectroscopic ellipsometry data for the composite sample and based on the first optical model for the matrix material.

2. The method of claim 1, wherein the first and second optical models comprise respective first and second optical oscillator models.

3. The method of claim 1, wherein generating the second optical model comprises generating the second optical model of the particulate material based on the spectroscopic ellipsometry data for the composite sample, based on the first optical model, and based on an estimate of a proportion of the polished surface that is made up of the particulate material.

4. The method of claim 3, wherein generating the second optical model comprises generating the second optical model as a best fit to the spectroscopic ellipsometry data for the composite sample based on the first optical model and based on the estimate of the proportion of the polished surface that is made up of the particulate material.

5. The method of claim 3, wherein the estimate of the proportion of the polished surface that is made up of the particulate material is determined based on proportions of the particulate material and the matrix material in the composite sample.

6. The method of claim 3, wherein the proportions of the particulate material and the matrix material in the composite sample are volumetric proportions.

7. The method of claim 1, wherein providing the first optical model for the matrix material comprises,
providing a reference sample having a polished surface, wherein the reference sample comprises the matrix material without the particulate material,
performing spectroscopic ellipsometry on the polished surface of the reference sample to provide spectroscopic ellipsometry data for the reference sample, and
generating the first optical model for the matrix material based on the spectroscopic ellipsometry data for the reference sample.

8. A system to determine optical properties of a particulate material, the system comprising:
a spectroscopic ellipsometer (803) configured to perform spectroscopic ellipsometry on a polished surface of a composite sample (805) to provide spectroscopic ellipsometry data for the composite sample (805); and
a controller (801) coupled with the spectroscopic ellipsometer (803) wherein the controller (801) is configured to generate an optical model for the particulate material based on the spectroscopic ellipsometry data for the composite sample and based on an optical model for the matrix material.

9. The system of claim 8, wherein the optical model for the matrix material and optical model for the composite particulate material comprise respective optical oscillator models.

10. The system of claim 8, wherein the controller (801) is configured to generate the optical model of the particulate material based on the spectroscopic ellipsometry data for the composite sample, based on the optical model for the matrix material, and based on an estimate of a proportion of the polished surface that is made up of the particulate material.

11. The system of claim 10, wherein the controller (801) is configured to generate the optical model of the particulate material as a best fit to the spectroscopic ellipsometry data for the composite sample based on the optical model for the matrix material and based on the estimate of the proportion of the polished surface that is made up of the particulate material.

12. The system of claim 10, wherein the estimate of the proportion of the polished surface that is made up of the particulate material is determined based on proportions of the particulate material and the matrix material in the composite sample.

13. The system of claim 10, wherein the proportions of the particulate material and the matrix material in the composite sample are volumetric proportions.
